(19) United States
(12) Patent Application Publication
(10) Pub. No.: US 2009/0233015 A1
(43) Pub. Date: Sep. 17, 2009

(54) PRINTING SHEET

(75) Inventors: Tadashi Fujimoto, Yamaguchi (JP); Koki Hirayama, Yamaguchi (JP)

Correspondence Address: BIRCH STEWART KOLASCH & BIRCH, PO BOX 747, FALLS CHURCH, VA, 22040-0747, US

(73) Assignee: TOKUYAMA CORPORATION, SHUNAH-SHI YAMAGUCHI (JP)

(21) Appl. No.: 12/374,843

(22) PCT Filed: Jul. 24, 2007
(86) PCT No.: PCT/JP2007/064833

§ 371 Date: Jan. 23, 2009

(30) Foreign Application Priority Data
Jul. 24, 2006 (JP) 2006-200208

(51) Int. Cl. B41M 5/50

(52) U.S. Cl. 428/32.1

(57) ABSTRACT

A printing sheet of this invention includes a substrate sheet and a printing layer which is formed on a surface of the substrate sheet and contains a semi-solidified plaster precursor. Printing is effected on the surface of the printing layer by using, for example, an ink-jet printer. Upon effecting the printing by using the printing sheet, a highly durable image can be vividly formed featuring rugged feeling and painting-like deepness.

### TECHNICAL FIELD

This invention relates to a printing sheet in which a printing surface is formed by a printing layer which contains a semi-solidified plaster wherein, after the printing, the plaster undergoes the carbonation and the printed image is firmly held in the printing surface.

### BACKGROUND ART

Accompanying a widespread use of personal computers and digital cameras in general households, ink-jet printers capable of printing vivid full-color images have now been widely used due also to their reasonable prices. As the printing papers for use with the ink-jet printers, the ordinary fine papers and coated papers cannot be used from the standpoint of their properties. Namely, the printing papers must meet such properties that the ink adhered to the paper surface is quickly absorbed therein, ink drops on the paper surface are suppressed from spreading or oozing contributing to forming vivid images, and colors of the formed images are not faded for extended periods of time offering excellent fastness.

In order to impart such properties to the printing surface (paper surface), it has been proposed to apply various inorganic solid materials together with a binding agent onto the surface of the paper or to fill them in the paper. For example, a patent document 1 proposes the use of a synthetic silica or a salt thereof as an inorganic solid material, a patent document 2 proposes forming a weakly acidic salt or an oxide of a divalent metal such as magnesium or zinc as a coating on the surface of the paper, a patent document 3 proposes forming a coating containing natural or synthetic zeolite, diatomaceous earth or synthetic mica on the surface of the paper, patent documents 4 and 5 propose forming an ink-absorbing layer by using a white pigment such as clay, talc, calcium carbonate, kaolin, acidic terra abla or active terra abla, and a patent document 6 proposes filling porous spherical silicate particles.

Patent document 1: JP-A-57-157786
Patent document 2: JP-A-58-94491
Patent document 3: JP-A-59-68292
Patent document 4: JP-A-58-89391
Patent document 5: JP-A-59-95188
Patent document 6: JP-A-9-309265

### DISCLOSURE OF THE INVENTION

However, the above conventional known printing papers inclusive of those used for ink-jet printers and other printers such as laser printers all form flat images like photographs but are not capable of forming images having a depth like that of paintings.

Further, when printed, the above known printing papers have no function for protecting the ink component from ultraviolet rays or ozone, and are not suited for being preserved for extended periods of time.

It is, therefore, an object of the present invention to provide a printing sheet capable of vividly forming a fast image having rugged appearance and depth like a painting, protecting the ink component from the ultraviolet rays and ozone after the printing, and preventing the fading of colors.

Another object of the invention is to provide a printing sheet capable of forming the above image when printed by using an ink-jet printer and a printing method.

By using a kneaded product of a slaked line (calcium hydroxide) and water, the present inventors have applied a plaster precursor obtained by carbonating the slaked lime but before the plaster has been completely carbonated onto a printing surface, and have discovered a novel knowledge in that when an image is printed on the plaster precursor layer, an image is formed having rugged appearance and deepness while protecting the ink component from such deteriorating factors as ultraviolet rays, etc. and preventing the fading of colors, and have completed the present invention.

That is, according to the present invention, there is provided a printing sheet including a substrate sheet and a printing layer which is formed on a surface of the substrate sheet and contains a semi-solidified plaster therein.

In the printing sheet of the invention, it is desired that:

(1) The printing layer contains, in an amount of at least 10% by weight, calcium hydroxide that is contained in the semi-solidified plaster;
(2) The printing layer contains a binder material comprising a solid component of polymer emulsion in an amount of 3 to 50% by weight;
(3) On the printing layer, a peelable protection sheet is laminated;
(4) The printing sheet is preserved being wrapped with a nonpermeable film;
(5) The printing sheet is held being wound like a roll, and the roll of the printing sheet is preserved being wrapped with the nonpermeable film;
(6) The printing sheet has a flat shape, and each piece thereof is preserved being wrapped with the nonpermeable film;
(7) The printing sheet has a flat shape, is held in a stacked form, and a stacked material thereof is preserved being wrapped with the nonpermeable film; and
(8) The printing sheet is used as an ink-jet recording material.

In the printing sheet of the present invention, it is desired that the printing layer on the substrate sheet contains a plaster in a semi-solidified state (hereinafter often called plaster precursor). The plaster is the one in which a slurry of calcium hydroxide (slaked lime) has reacted with a carbonic acid gas and turned into the calcium carbonate having excellent fastness, while the plaster in the semi-solidified state, i.e., the plaster precursor is the one in which the calcium hydroxide is partly remaining without being carbonated. The printing layer containing the plaster precursor is very porous and rich in hydrophilic property in the surface thereof permitting an ink to deeply permeate therein for forming an image. Thereafter, the remaining calcium hydroxide is carbonated and is completely solidified to turn into the plaster. As a result, the printed image offers distinguished advantages such as excellent fastness without permitting colors to be lost by wiping. Besides, the printed layer has a large degree of ruggedness in the surface thereof. Therefore, the image printed thereon exhibits rugged appearance and deepness like that of a painting akin to a wall painting, which is quite different from photographic images. That is, with the conventionally known printing and recording papers, ruggedness is very fine in the surfaces even if a layer of an inorganic solid material were formed on the printing surfaces and, therefore, the surfaces are in a flat state if viewed macroscopically. Therefore, the images that are formed are close to those of photography, and images having deepness like that of a painting cannot be formed.

It is, further, desired to provide a protection sheet on the surface of the printing layer maintaining a suitable peelable force. Provision of the protection sheet not only effectively prevents the damage to the printing layer but also enables the surface of the printing layer to be partly removed at the time of effecting the printing by peeling the protection sheet off, making it possible to reliably form the above-mentioned ruggedness in the surface of the printing layer.

According to the present invention, further, the ink for forming the image deeply infiltrates into the printing layer which contains the plaster in the semi-solidified state and, thereafter, the printing layer is exposed to the air, whereby the plaster precursor reacts with the carbonic acid gas to form a plaster (calcium carbonate) that features excellent fastness. Here, when the printing ink (usually, an aqueous ink) is applied onto the surface of the printing layer, the calcium hydroxide in the printing layer elutes out in the water content of the printing ink and floats on the surface in the form of a thin layer. Therefore, a thin layer (plaster layer) of calcium carbonate is formed on the surface of the image printed on the printing surface and serves as a protection layer which protects the printed image from the ultraviolet rays and ozone in the air, prevents the color of the printed image from fading, and makes it possible to preserve the printed image vividly for extended periods of time.

The printing sheet of the present invention can be very effectively used, particularly, as a recording material for use with the ink-jet printer. By also printing photographic images on the printing sheet of the invention by using, for example, digital cameras, the images can be transformed into those resembling paintings and can, further, be prevented from deteriorating.

### BRIEF DESCRIPTION OF THE DRAWING

FIG. 1 is a sectional view schematically illustrating the structure of a printing sheet of the present invention.

### BEST MODE FOR CARRYING OUT THE INVENTION

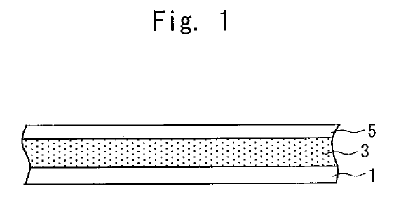

Referring to FIG. 1, the printing sheet of the present invention includes a substrate sheet 1 and a printing layer 3 formed thereon. As required, further, a protection sheet 5 is provided on the printing layer 3. That is, in the printing sheet, the printing layer 3 contains a plaster in a semi-solidified state (plaster precursor). Upon peeling off the protection sheet 5 that is provided as required, the printing is effected on the surface of the exposed printing layer 3.

There is no particular limitation on the substrate sheet 1 if the printing layer 3 containing the plaster precursor can be formed on the surface thereof, and any material may be used. For example, there can be used various kinds of paper, resin sheets or resin films of vinyl resins such as polyvinyl alcohol, polyvinyl acetate and poly(methacrylate; polyolefin resins such as polyethylene and polypropylene; and polyester resins such as polyethylene terephthalate and the like; as well as woven fabrics or nonwoven fabrics comprising fiber materials, such as glass fiber, vinylon fiber, polypropylene fiber, polyester fiber, polyethylene terephthalate fiber, acrylic fiber, aramid fiber and carbon fiber; as well as laminated films or sheets thereof. Generally, however, it is desired that the substrate sheet 1 has flexibility and a suitable degree of stiffness. Even if folded, the above substrate sheet 1 forms a crease little and effectively suppresses such an inconvenience that creases are formed in the printing layer 3 containing the plaster precursor formed on the substrate sheet 1. Though the materials of the above substrate sheet may be considerably limited, a glass fiber-mixed paper is, usually, preferably used. The glass fiber-mixed paper is obtained by mixing a wood pulp and a glass fiber together, features flexibility and bending strength, and can be favorably and closely adhered to the printing layer 3. In addition to the glass fiber-mixed paper, there can be used a synthetic paper obtained by mixing a chemical fiber such as polyvinyl acetate fiber, polyester fiber or vinylon fiber as a binder fiber. The glass fiber-mixed paper which in the present invention can be most preferably used as the substrate sheet 3 is a paper that has been placed in the market from Hokuetsu Seishi Co. in the trade name of “MPS-01”.

The surface of the substrate sheet 1 may be treated with a corona to improve hydrophilic property. This makes it possible to improve the junction strength between the printing layer 3 that will be described below and the substrate sheet 1.

The thickness of the substrate sheet 1 is set in a suitable range depending upon the use. For example, when used as a recording material for printers, the thickness of the substrate sheet 1 is so set that the printing sheet can easily pass through the printer.

In the present invention, the printing layer 3 is formed by coating the hydrophilic surface of the substrate sheet 1 with a kneaded product of the powder of slaked lime (calcium hydroxide) and water. When the layer is left to stand in the air, the plaster precursor in the semi-solidified state (mixture of slaked lime and calcium carbonate) absorbs the carbonic acid gas in the air, whereby the slaked lime in the plaster precursor reacts with the carbonic acid gas to form the calcium carbonate which is further solidified to form the plaster. That is, the printing layer 3 is a layer that contains the plaster precursor in a semi-solidified state where the calcium carbonate is present as the slaked lime is partly carbonated.

In the present invention, the above printing layer 3 contains the plaster precursor in a semi-solidified state of before the calcium hydroxide (slaked lime) is completely carbonated and is completely solidified. Desirably, the printing layer 3 is the one in which the calcium hydroxide is contained in an amount of at least 10% by weight and, preferably, not less than 15% by weight in the plaster precursor. If the content of the calcium hydroxide is smaller than the above range, the fastness of the image decreases and colors tend to fade out. Further, when the printing is effected by applying the printing ink onto the surface of the printing layer 3, a decreased amount of calcium hydroxide elutes out in the printing ink and floats on the surface causing such inconveniences as decreased effect for protecting the printed image and decreased effect for suppressing the deterioration of the printed image.

It is desired that the calcium hydroxide is present in large amounts in the printing layer for achieving the above objects. However, if present in too large amounts, the printing layer 3 is not sufficiently hardened and tends to be damaged in the step of printing. It is, therefore, desired that the calcium hydroxide is present in an amount of not larger than 85% by weight and, preferably, not larger than 80% by weight in the printing layer 3.

The ratio of the calcium hydroxide in the printing layer can be confirmed by the neutralization titration.

In the present invention, the content of calcium hydroxide in the printing layer 3 can be adjusted by adjusting the ratio of carbonating the calcium hydroxide used for forming the printing layer 3 (weight ratio of the formed calcium carbonate to the weight of the slaked lime used for preparing the slurry) and adjusting the ratio of the additives such as a binder that will be described later, an inorganic fine aggregate and a liquid-absorbing inorganic powder.

Of the above adjusting methods, if a method is employed for adjusting the ratio of carbonating the calcium hydroxide used for forming the printing layer 3, it is desired that the upper limit of the carbonation ratio is 80% and, particularly, 40%. That is, if the carbonation proceeds excessively, the surface of the printing layer becomes dense and the permeation of the printing ink decreases. The degree the surface is made dense by carbonation can be determined by the abrasion resistance of the surface of the printing layer described in Examples appearing later. The printing layer in which the carbonation is halted in a state where the abrasion resistance is class 4 or lower is suited in the present invention.

In the present invention, after the image is printed, the printing layer 3 is left to stand in the atmosphere whereby the plaster precursor in the printing layer 3 is carbonated and finally turns into the plaster. In order to improve the toughness of the printing layer 3, it is desired that the printing layer 3 contains a solid component of polymer emustion as a binder. The polymer emulsion is obtained by dispersing a monomer, an oligomer or a polymer thereof in an aqueous medium, such as an emulsion of such a polymer as acrylic resin, vinyl acetate resin, polyurethane, or styrene/butadiene rubber. In the step of drying, the solvent (water) in the emulsion evaporates and the polymer component in the emulsion remains in the printing layer 3. That is, if the solid component (i.e., polymer) is present in an excess amount in the emulsion, permeation of the printed image (printing ink) in the printing layer 3 tends to decrease. To enhance the toughness of the printing layer 3 and to maintain the permeation of the ink, therefore, it is usually desired that the solid component in the polymer emulsion in the printing layer 3 is in a range of 3 to 50% by weight.

In addition to the emulsion, the printing layer 3 may be further blended with various additives such as various fiber materials, an inorganic fine aggregate, a liquid-absorbing inorganic powder, etc. for adjusting the properties of the printing layer 3. These additives work to improve physical properties such as strength, etc. of the printing layer 3.

Examples of the fiber material include glass fiber, vinylon fiber, polypropylene fiber, polyeter fiber, polyethylene terephthalate fiber, acrylic fiber, aramid fiber, carbon fiber and metal fiber. Further, the fiber of such a shape can be used as staple fiber, filament, woven fabric or nonwoven fabric. Among them, the staple fiber is particularly effective in improving the toughness and cut workability of the plaster layer 3. Though there is no particular limitation on the length and diameter of the staple fiber, it is desired that the length is 1 mm to 10 mm and, particularly, 2 mm to 6 mm and the diameter is 5 to 50 μm and, particularly, 10 to 30 μm from the standpoint of further improving the toughness of the printing layer 3 and, depending upon the cases, obtaining excellent cut workability.

The inorganic fine aggregate is an inorganic particulate material having an average particle size in a range of about 0.01 to about 2 mm and, within this range, having an average particle size of not larger than one-half the thickness of the printing layer 3. Concrete examples thereof include silica sand, lime sand, mica, glazed silica sand, glazed mica, ceramic sand, glass beads, perlite and calcium carbonate.

It is further desired in the present invention to also use a liquid-absorbing inorganic powder in order to compensate for a decrease in the affinity to the hydrophilic ink caused by the use of the polymer emulsion in the printing layer 3 and to compensate for the liquid-absorbing property that decreases as the calcium hydroxide in the printing layer 3 carbonates. The liquid-absorbing inorganic powder is a fine inorganic powder which is porous and can absorb an oil in an amount of not less than 100 ml/100 g, such as an alumina powder or a zeolite powder having an average particle size (D₅₀) of not larger than 0.1 μm calculated as volume as measured by, for example, a laser diffraction scattering method.

The above polymer emulsion is effective in improving the toughness and enhancing the junction strength between the substrate sheet land the printing layer 3 accompanied, however, by such inconveniences as decreased hydrophilic property of the printing layer 3 repelling the ink when the printing is effected by using, for example, a hydrophilic ink and blurring the printed image. Here, use of the above-mentioned liquid-absorbing inorganic powder is preferred from the standpoint of improving the absorption of the printing ink and effectively-preventing the above inconveniences. It is, particularly, desired that the liquid-absorbing inorganic powder is contained in the printing layer 3 in an amount of about 0.5 to about 10% by weight.

In the present invention, the additives may be added to the printing layer 3 in a single kind or in two or more kinds depending upon the object. In any case, the additives should be added in amounts of a degree that does not impair the permeation of the printing ink into the printing layer 3 or the fixing thereof. For example, it is desired that various kinds of additives are added in a range in which the amount of the calcium carbonate formed by the carbonation of the slaked lime (i.e., the content of the calcium carbonate of when the carbonation ratio is 100%) is maintained to be not less than 50% by weight.

The thickness of the printing layer 3 is maintained in a suitable printable range and, generally, in a range of about 0.05 to about 0.3 mm and, particularly, about 0.1 to about 0.25 mm. If the thickness is too small, the image-fixing property decreases when the image is printed due to the permeation of the printing ink or the deepness of the expressed image is spoiled due to ruggedness. On the other hand, a too large thickness becomes disadvantageous in economy, easily forms creases when bent imposing limitation on the printer that is used for printing.

Further, the printing layer 3 comprises inorganic particles (particles of calcium hydroxide and calcium of carbonates), and is relatively brittle, is subject to be damaged by the pressure from the exterior, and loses the commercial value. It is, therefore, desired to protect the surface of the printing layer 3 from just after the production of the printing sheet until the printing is effected by general users. For this purpose, therefore, the printing sheet of the present invention may have a protection sheet 5 provided on the upper surface of the printing layer 3. The protection sheet 5 is peeled off at the time of the printing. When peeled off, the protection sheet 5 exhibits a function of forming a conspicuous degree of ruggedness in the surface of the printing layer 3 by partly removing the surface thereof. It is, therefore, desired that the protection sheet 5 is provided maintaining a peeling strength of, for example, 200 to 4000 mN/25 mm and, particularly, 800 to 3000 mN/25 mm. That is, if the peeling strength is too high, it becomes difficult to peel off the protection sheet 5 at the time of printing. If the peeling strength is too low, it becomes difficult to form ruggedness of a sufficiently large degree in the surface of the printing layer 3 when the protection sheet 5 is peed off.

The peeling strength is measured in compliance with the JIS-K6854-2, Adhesive—Method of Testing the Peeling Strength—Section 2: 180 Degrees Peeling, by using a sample of a width of 25 mm while pulling it at a tension speed of 300 mm/min.

The above protection sheet 5 may be made from any material so far as it has a protection function and can be provided on the printing layer 3 maintaining the above-mentioned peeling strength. As the protection sheet 5, however, there are, generally, used woven fabrics or nonwoven fabrics comprising fiber materials, such as glass fiber, vinylon fiber, polypropylene fiber, polyester fiber, polyethylene terephthalate fiber, acrylic fiber, aramid fiber and carbon fiber; as well as laminated films or sheets thereof. As the protection sheet 5, further, there can be used a non-permeable sheet such as a silicon paper to impart the function for protecting the printing layer 3 as will as the function for preventing the carbonation of the printing layer 3 until the printing.

The protection sheet 5 may have such a thickness that exhibits a suitable protection function, which is, usually, about 0.01 to about 2.0 mm.

The above printing sheet of the invention is produced by forming the printing layer 3 by applying a slurry for forming a plaster onto one surface of the substrate sheet 1 for forming the printing layer 3 and, at the same time, sticking the protection sheet 5 thereon as required, followed by drying to a suitable degree.

The slurry for forming the plaster is obtained by adding the above binder and various additives to the kneaded product of the powder of slaked lime and water.

It is desired that the powder of slaked lime used for preparing the slurry comprises fine particles of particle sizes of, for example, not larger than 5 μm in an amount of 20 to 80% by weight and coarse particles of particle sizes of 10 to 50 μm in an amount of 10 to 40% by weight. That is, the fine particles are effective in imparting the shape-retaining property and strength of the printing layer 3 while the coarse particles are effective in maintaining image permeability. Use of the slaked lime powder containing the fine particles and the coarse particles in amounts of the above ratio is very desired for forming the plaster layer having favorable strength and durability without impairing the image permeability. For example, if the slaked lime powder comprising the above fine particles only is used, the ink permeability will be lost and the fastness of the printed image will decrease.

It is further desired that the slurry is prepared having a suitable degree of viscosity by being blended with a surfactant for homogeneously dispersing the additives and by being blended with a suitable viscosity-imparting agent so that the kneaded product thereof will not drip at the time of application. The slurry can be applied by using a bar coater, a roll coater, a flow coater, a knife coater, a comma coater, a spraying, a dipping, an ejection or a transfer of a material. As required, further, there can be employed a trowel holder, a mouth piece squeezer, transfer of pressure by roller, or a monoaxial press.

The thickness of the slurry that is applied is so set that the thickness after drying becomes the thickness of the above-mentioned printing layer 3. Further, the drying after the slurry is applied may be effected to such a degree that the content of water in the printing layer 3 is not larger than 5%. If the content of water is too high, the form of the layer cannot be maintained. Or, if the printing is effected in a state where the high content of water is maintained, the ink easily blurs. The drying is effected by blowing the hot air in a manner that the layer on which the slurry is applied is heated at about 40 to about 150° C. Here, attention must be paid to that if the heating temperature is set to be too high, the substrate sheet 1 and the protection sheet 5 tend to be deformed due to heat.

The carbonation reaction of the calcium hydroxide (slaked lime) proceeds upon coming in contact with the carbonic acid gas. Therefore, as far as the slurry is preserved in a sealed state in a nonpermeable bag or a container, there is no problem in maintaining a predetermined carbonation ratio and in maintaining the amount of calcium hydroxide in the printing layer 3 in a predetermined range.

The protection sheet 5 is stuck and laminated on the thus formed printing layer 3. Provision of the protection sheet 5 protects the surface of the printing layer 3 in the stage of before effecting the printing, and effectively prevents the printing layer 3 from being damaged by the external pressure at the time of preserving or transporting the printing sheets. As described already, the protection sheet 5 is stuck to the printing layer 3 maintaining a peeling strength in a predetermined range. Though there is no particular limitation on the means for obtaining the peeling strength, it is desired that the protection sheet 5 is stuck by being closely adhered to the printing layer 3 without via an adhesive so will not to adversely affect the printing layer 3. Concretely, it is most desired to laminate the protection sheet 5 immediately after the slurry is applied onto the surface of the substrate sheet 1, and to carbonate the slurry layer to a suitable degree in this state. According to this method, the protection sheet 5 is closely adhered and fixed to the printing layer 3 maintaining a predetermined peeling strength in the step (e.g., drying step) in which the calcium hydroxide carbonates upon reacting with carbon dioxide. Here, the peeling strength can be adjusted by adjusting the material of the protection sheet 5, adjusting the composition that contains curing components used for forming the printing layer 3 and, particularly, adjusting the amounts of the blended components that affects the affinity of the aqueous emulsion, etc.

The printing sheet is produced as described above, usually, having the protection sheet 5 stuck to the surface of the printing layer 3. As described above, the protection sheet 5 has the function of protecting the surface of the printing layer 3 when the printing sheet is being handled, and can be placed in the market being stuck thereto. However, effecting the printing while peeling the protection sheet off the printing sheet often results in a decrease in the workability. In particular, the problem becomes serious when the printing sheet has a large area. In such a case, it would also be a preferred embodiment to place in the market the printing sheet in a state where the protection sheet has already been peeled off though it was once stuck to the printing sheet in the step of production. That is, in the present invention, the printing-sheet is placed in the market as a product to which the protection sheet has been stuck or from which the protection sheet has been peeled. If the printing layer 3 is left to stand in the atmosphere, however, the plaster precursor undergoes the carbonation, and the printability (e-g., permeation and fixing of image) decreases. To avoid such inconvenience, the carbonation must be suppressed until the moment of printing.

As a method of suppressing the carbonation of the printing layer, for example, a long printing sheet cut to a suitable size may be wound like a roll which is, then, preserved being wrapped with a nonpermeable film. Or, a number of pieces of the printing sheets may be stacked one upon the other, and the stack thereof may be preserved being wrapped with the nonpermeable film.

When the protection sheet 5 is being stacked, further, the nonpermeable film may be laminated on the upper surface of the protection sheet 5 and on the back surface of the substrate sheet 1 to preserve.

As the nonpermeable film, there is no particular limitation, and various kinds of resin films can be used that have usually been used as films for packing. From the standpoint of cost, however, it is most desired to use a polyolefin film such as polyethylene film.

The printing sheet placed in the market as described above is used by removing the packing film. When the protection sheet 5 is present, the surface of the printing layer 3 is exposed by peeling the protection sheet 5 off, and the printing is effected on the surface.

As for printing means, the printing can be continuously effected in a predetermined size by the gravure printing by using an ink in which a predetermined pigment or a dye has been dispersed or dissolved, or the printing can be effected by using an ink-jet printer. The ink to be used is most desirably a hydrophilic ink in which a water-soluble dye is dissolved or that is obtained by dispersing a pigment in water (or in a water/alcohol mixed solvent) by using a surfactant. When the hydrophilic ink is used, sharp images can be formed on the printing layer 3 being stably held without blurring. In particular, an ink using a pigment is preferably used in the present invention.

When left to stand in the atmosphere (usually, for about 0.5 to about 30 days) as described already, the printing layer 3 on which the image is printed as described above absorbs the carbonic acid gas in the atmosphere whereby the remaining calcium hydroxide undergoes the carbonation and solidification to turn into the plaster. Therefore, the image permeates into the rugged and porous plaster and is fixed to appear like a wall image featuring deepness as compared to photographic images.

Further, the formed image features excellent fastness without permitting colors to fade even if rubbed and, further, protects the ink components from infrared rays, and can be stably maintained for extended periods of time.

The printing sheet of the present invention forms images like pictures on a wall. Even when photographic images shot by using, for example, a digital camera are printed, painting-like images are formed featuring solid feeling and deepness without deteriorating for extended periods of time.

Therefore, the printing sheet of the invention is very useful as an ink-jet recording material, particularly, for use with the ink-jet printer.

### EXAMPLES

Excellent effects of the invention will now be described by way of Experiments.

Described below are testing methods and materials used in Experiments.

### (1) Blurring Ratio of Image:

By using an ink-jet printer (PM-4000PX manufactured by Epson Co., using water-soluble inks in which pigments are dispersed), circular images of a diameter of 10 mm were printed on the surfaces of printing sheets prepared under the conditions of Examples and Comparative Examples. The obtained printed images (circular images) were read as digital images by a personal computer by using a color scanner placed in the market, and the numbers of pixels of the transferred colors were measured by using an image-processing software and were compared with the numbers of pixels of when printed on a paper (plain paper) dedicated for use in the ink-jet printer to calculate the blurring ratio (SR) according to the following formula,

SR=P1/P0
SR: blurring ratio (−); usually 1 or larger, the value increases with an increase in the blurring.
P1: number of pixels (pixels) of the printed image.
P0: number of pixels (pixels) of the image printed on the paper dedicated for use in the ink-jet printer.

### (2) Abrasion Resistance Testing:

Abrasion when wet was tested in compliance with the JIS-A 6921 to measure the degree (class) of abrasion resistance as evaluated in five steps.
Degree of abrasion resistance: evaluated in five steps of classes 1 to 5; class 5 is the highest degree of abrasion resistance.

### (3) Weather-Proof Testing:

There were provided printing papers (A4-size) prepared under the conditions of Examples and Comparative Examples and printing papers (A4-size) placed in the market. Each piece of these papers was divided into four equal regions. By using an ink-jet printer (PM-4000PX manufactured by Epson Co., using water-soluble inks in which pigments are dispersed), four colors, i.e., yellow, red, blue and black, were printed onto the four regions. The thus printed papers were provided each in two pieces. The printed papers each in a piece were irradiated with ultraviolet rays of an intensity of 500 μW/cm² by using an ultraviolet-ray irradiating fluorescent lamp (fluorescent lamp, Model FL30SBL-360 manufactured by Mitsubishi Denki Co.), and the remaining papers each in a piece were preserved in a dark place.

The papers irradiated with the ultraviolet rays for a predetermined period of time and the papers preserved in a dark place were taken out, and were found for their color differences (ΔE1 to ΔE4) in the L*, a* and b* coloring systems of colors in the ultraviolet ray-irradiated portions and in the non-irradiated portions for the four colors of yellow, red, blue and black in compliance with the JIS Z 8730 by using a spectral color difference meter (handy spectral color difference meter, Model NF333, manufactured by Nihon Denshoku Kogyo Co.). Further, the color differences were averaged according to the following formula to find ΔEav to use it as an index for weather-proof property.

ΔEav=(ΔE1+ΔE2+ΔE3+ΔE4)/4

Here, the value increases with an increase in the change of color.
ΔE1: Color difference in the yellow region between the ultraviolet ray-irradiated portion and the non-irradiated portion.
ΔE2: Color difference in the red region between the ultraviolet ray-irradiated portion and the non-irradiated portion.
ΔE3: Color difference in the blue region between the ultraviolet ray-irradiated portion and the non-irradiated portion.

ΔE4: Color difference in the black region between the ultraviolet ray-irradiated portion and the non-irradiated portion.

### (A) Substrate Sheet:

Calcium carbonate paper: “OK COSMO CA 135” (trade name), manufactured by Oji Seishi Co. (thickness: 0.18 mm, weight: 138 g/m²)
Glass fiber-mixed paper: “MPS-01” (trade name), manufactured by Hokuetsu Seishi Co. (thickness: 0.35 mm, weight: 85 g/m²)

### (B) Calcium Hydroxide:

Slaked lime: “High-Purity Slaked Lime CH” (trade name), manufactured by Ube Materials Co.

### (C) Inorganic Powders:

Calcium carbonate: “White 7” (trade name), manufactured Yakusen Sekkai Co.
Calcium sulfate: (dihydrate, special grade chemical), manufactured by Wako Junyaku Co.

### (D) Aqueous Emulsion:

Polytron: “Polytron A 1480” (trade name), manufactured by Asahi Kasei Kogyo Co.
(Acrylic copolymerized latex, solid component: 40% by weight)

### (E) Liquid-Absorbing Inorganic Powder:

Fine alumina powder: average particle size (D₅₀) 0.05 μm, oil-absorbing amount: 180 ml/100 g

### (F) Protection Sheet:

Nonwoven fabric A: BT-1306 WM (trade name), manufactured by Unicel Co.

### Preparation Examples 1 to 3

A slurry of slaked lime was obtained by kneading 100 parts by weight of slaked lime, 30 parts by weight of an aqueous emulsion, 40 parts by weight of water and 5 parts by weight of a liquid-absorbing inorganic powder. Next, by using a calcium carbonate paper (300×200 mm) as the substrate sheet, the above slurry of slaked lime was applied onto the surface thereof by using a bar coater and, immediately thereafter, a nonwoven fabric A (protection sheet) was closely adhered onto the surface of the slurry followed by drying in a drying machine at 50° C. for 30 minutes. The printing layers formed after drying possessed a thickness of 100 μm on average.

Thereafter, the printing layers were left to stand in a room for 0 day, 10 days and 20 days to carbonate the slaked lime (calcium hydroxide), and printing sheets were obtained having printing layers containing semi-hardened plasters having different degrees of carbonation.

Table 1 shows the ratios of slaked lime in the printing layers of the obtained printing sheets in combination with the abrasion resistances of the printing layers.

### Comparative Preparation Examples 1 and 2

Printing sheets having printing layers were obtained by using slurries of similar compositions in the above Examples but using the calcium carbonate (Comparative Example 1) and the calcium sulfate (Comparative Example 2) instead of using the slaked lime. Here, the printing layers were not carbonated.

Table 1 shows the ratios of slaked lime in the printing layers of the obtained printing sheets in combination with the abrasion resistances of the printing layers.

TABLE 1

| | | Ratio of slaked | |
|---|---|---|---|
| | Carbonation | lime in the | Abrasion |
| | time | printing layer | resistance |
| | (days) | (wt %) | (class) |
| Prep. Ex. 1 | 0 | 60 | 4 |
| Prep. Ex. 2 | 10 | 16 | 5 |
| Prep. Ex. 3 | 20 | 11 | 5 |
| Comp. | — | 0 | 1 |
| Prep. Ex. 1 | | | |
| Comp. | — | 0 | 2 |
| Prep. Ex. 2 | | | |

### Examples 1 to 3 and Comparative Examples 1 and 2

The printing sheets obtained in Preparation Examples 1 to 3 and in Comparative Preparation Examples 1 and 2 were used for printing four colors of yellow, red, blue and black, were left to stand in a room for 20 days so as to be carbonated, and were subjected to the weather-proof testing. In the weather-proof testing, average color differences (ΔEav) were measured after one month and 4 months have passed as shown in Table 2. Table 2 also shows the abrasion resistances after left to stand in the room for 20 days.

TABLE 2

| | | | |
|---|---|---|---|
| | | | Average color difference |
| Examples/ | Blurring | Abrasion | (ΔEav) |

| Comp. | ratio | resistance | After | After |
|---|---|---|---|---|
| Examples | (—) | (class) | one month | 4 months |
| Example 1 | 1.04 | 5 | 2.3 | 5.1 |
| Example 2 | 1.09 | 5 | 1.9 | 4.3 |
| Example 3 | 1.11 | 5 | 1.5 | 3.6 |
| Comp. | 1.29 | 1 | 3.7 | 9.9 |
| Example 1 | | | | |
| Comp. | 1.37 | 2 | 4.8 | 15.1 |
| Example 2 | | | | |

### Preparation Examples 4 to 6

A slurry of slaked lime was obtained by kneading 100 parts by weight of slaked lime, 30 parts by weight of an aqueous emulsion and 40 parts by weight of water. Next, by using a glass fiber-mixed paper (300×200 mm) as the substrate sheet, the above slurry of slaked lime was applied onto the surface thereof by using a bar coater and, immediately thereafter, a nonwoven fabric A (protection sheet) was closely adhered onto the surface of the slurry followed by drying in a drying machine at 50° C. for 30 minutes. Here, the amount of applying the slurry of slaked lime was adjusted so that the thickness of the printing layer formed after drying was as shown in Table 3.

Table 3 shows the ratios of slaked lime in the printing layers of the obtained printing sheets.

Table 3 shows the occurrence of cracks of when the printing sheets are bent by 90 degrees after the protection sheets have been peeled off the obtained printing sheets. Table 3 further shows the abrasion resistances of the printing layers.

TABLE 3

| | | | | Slaked lime |
|---|---|---|---|---|
| | Thickness of | | Abrasion | content in the |
| | printing layer | | resistance | printing layer |
| | (μm) | Cracks | (class) | (wt %) |
| Prep. | 70 | none | 4 | 50 |
| Ex. 4 | | | | |
| Prep. | 120 | none | 4 | 64 |
| Ex. 5 | | | | |
| Prep. | 280 | none | 4 | 72 |
| Ex. 6 | | | | |

### Examples 4 to 6

The printing sheets obtained in Examples 4 to 6 were used for printing four colors of yellow, red, blue and black, were left to stand in the room for 20 days so as to be carbonated, and were subjected to the weather-proof testing. Table 4 shows average color differences (ΔEav) in combination with the abrasion resistance after left to stand in the room for 20 days.

TABLE 4

| | | | |
|---|---|---|---|
| | | | Average color difference |
| Examples/ | Blurring | Abrasion | (ΔEav) |

| Comp. | ratio | resistance | After | After |
|---|---|---|---|---|
| Examples | (—) | (class) | one month | 4 months |
| Example 4 | 1.07 | 5 | 1.5 | 3.5 |
| Example 5 | 1.06 | 5 | 1.4 | 3.4 |
| Example 6 | 1.06 | 5 | 1.6 | 3.6 |

### Preparation Examples 7 and 8

Printing sheets were obtained in the same manner as in Example 5 but using the aqueous emulsion at ratios as shown in Table 5.

Table 5 shows the ratios of slaked lime in the printing layers of the obtained printing sheets in combination with the abrasion resistances of the printing layers.

TABLE 5

| | Ratio of | Ratio of slaked | | |
|---|---|---|---|---|
| | aqueous | lime in the | | Abrasion |
| | emulsion | printing layer | | resistance |
| | (pts. by wt.) | (wt %) | Cracks | (class) |
| Prep. | 5 | 45 | none | 4 |
| Ex. 7 | | | | |
| Prep. | 10 | 51 | none | 4 |
| Ex. 8 | | | | |

### Examples 7 and 8

The printing sheets obtained in Examples 7 and 8 were used for printing four colors of yellow, red, blue and black, were left to stand in the room for 20 days so as to be carbonated, and were subjected to the weather-proof testing. Table 6 shows average color differences (ΔEav) in combination with the abrasion resistance after left to stand in the room for 20 days.

TABLE 6

| | | | |
|---|---|---|---|
| | | | Average color difference |
| Examples/ | Blurring | Abrasion | (ΔEav) |

| Comp. | ratio | resistance | After | After |
|---|---|---|---|---|
| Examples | (—) | (class) | one month | 4 months |
| Example 7 | 1.10 | 5 | 1.4 | 3.5 |
| Example 8 | 1.11 | 5 | 1.5 | 3.6 |

### Example 9

The protection sheet was peeled off the printing sheet obtained by the same method as that of Preparation Example 1. Thereafter, the printing sheet was put into a polyethylene bag of a thickness of 100 μm and was sealed therein by heat-melt-adhesion. After 3 months have passed, the bag was opened to find that the ratio of calcium hydroxide in the printing layer was 57% by weight. Like in Example 1, the printing sheet was subjected to the weather-proof testing and measured for its abrasion resistance. As a result of the weather-proof testing, the average color difference was 2.5 after one month and 5.6 after 4 months. The abrasion resistance was class 5.

1. A printing sheet including a substrate sheet and a printing layer which is formed on a surface of said substrate sheet and contains a semi-solidified plaster therein.

2. The printing sheet according to claim 1, wherein said printing layer contains, in an amount of at least 10% by weight, the calcium hydroxide that is contained in said semi-solidified plaster.

3. The printing sheet according to claim 1, wherein said printing layer contains a binder comprising a solid component of polymer emulsion in an amount of 3 to 50% by weight.

4. The printing sheet according to claim 1, wherein a peelable protection sheet is laminated on said printing layer.

5. The printing sheet according to claim 1, wherein said printing sheet is preserved being wrapped with a nonpermeable film.

6. The printing sheet according to claim 5, wherein said printing sheet is held being wound like a roll, and the roll of said printing sheet is preserved being wrapped with said nonpermeable film.

7. The printing sheet according to claim 5, wherein said printing sheet has a flat shape, and each piece thereof is preserved being wrapped with said nonpermeable film.

8. The printing sheet according to claim 5, wherein said printing sheet has a flat shape, is held in a stacked form, and the stacked material thereof is preserved being wrapped with said nonpermeable film.

9. The printing sheet according to claim 1, which is used as an ink-jet recording material.
